(19) United States
(12) Patent Application Publication
(10) Pub. No.: US 2023/0304835 A1
(43) Pub. Date: Sep. 28, 2023

(54) INFORMATION PROVIDING SYSTEM, INFORMATION PROVIDING METHOD, AND RECORDING MEDIUM

(71) Applicant: Akito MORITA, Kanagawa (JP)

(72) Inventor: Akito MORITA, Kanagawa (JP)

(73) Assignee: Ricoh Company, Ltd., Tokyo (JP)

(21) Appl. No.: 18/167,185

(22) Filed: Feb. 10, 2023

(30) Foreign Application Priority Data
Feb. 17, 2022 (JP) 2022-023258

(51) Int. Cl. G01D 21/02; H04L 67/12

(52) U.S. Cl. CPC G01D 21/02; H04L 67/12

(57) ABSTRACT

An information providing system including circuitry; and a memory storing computer-executable instructions that cause the circuitry to execute connecting, via a network, to a first managing system configured to manage measurement information measured by a sensor; receiving, from the first managing system, the measurement information of the sensor and identification information identifying the sensor that has measured the measurement information; acquiring specific information corresponding to the received measurement information, from a storage in which the identification information of the sensor is associated with the specific information for specifying a resource on which the sensor is installed; generating environment information to be provided to a terminal, based on the acquired specific information and the received measurement information; and providing the generated environment information to the terminal.

### CROSS-REFERENCE TO RELATED APPLICATION

The present application is based on and claims priority under 35 U.S.C. §119 to Japanese Patent Application No. 2022-023258, filed on Feb. 17, 2022, the contents of which are incorporated herein by reference in their entirety.

### BACKGROUND OF THE INVENTION

### 1. Field of the Invention

The present invention relates to an information providing system, an information providing method, and a recording medium.

### 2. Description of the Related Art

A managing system that places sensors in a predetermined space and manages the environment of the space (for example, the temperature, the humidity, the carbon dioxide concentration, etc.), is known. In the case of this managing system, for example, by linking with a control system and the like, when the environment of the space deteriorates, the environment can be automatically improved.
Patent Document 1: Japanese Unexamined Patent Application Publication No. 2008-304124
Patent Document 2: Japanese Unexamined Patent Application Publication No. 2011-196683
Patent Document 3: Japanese Unexamined Patent Application Publication No. 2020-71621

### SUMMARY OF THE INVENTION

According to one aspect of the present invention, there is provided an information providing system including circuitry; and a memory storing computer-executable instructions that cause the circuitry to execute connecting, via a network, to a first managing system configured to manage measurement information measured by a sensor; receiving, from the first managing system, the measurement information of the sensor and identification information identifying the sensor that has measured the measurement information; acquiring specific information corresponding to the received measurement information, from a storage in which the identification information of the sensor is associated with the specific information for specifying a resource on which the sensor is installed; generating environment information to be provided to a terminal, based on the acquired specific information and the received measurement information; and providing the generated environment information to the terminal.

### BRIEF DESCRIPTION OF THE DRAWINGS

FIG. 1 is a first diagram illustrating an example of the system configuration of a network system according to a first embodiment of the present invention;

FIG. 2 illustrates an example of the hardware configuration of a server apparatus according to the first embodiment of the present invention;

FIG. 3 is a first diagram illustrating an example of the functional configuration of an information providing unit according to the first embodiment of the present invention;

FIG. 4 is a first flow chart illustrating the flow of an information providing process according to the first embodiment of the present invention;

FIG. 5 is a second diagram illustrating an example of the system configuration of a network system according to a second embodiment of the present invention;

FIG. 6 is a second diagram illustrating an example of the functional configuration of an information providing unit according to the second embodiment of the present invention;

FIGS. 7A to 7C are a first diagram illustrating an example of a display screen according to the second embodiment of the present invention;

FIG. 8 is a second flow chart illustrating the flow of an information providing process according to the second embodiment of the present invention;

FIG. 9 is a third diagram illustrating an example of the functional configuration of the information providing unit according to a third embodiment of the present invention;

FIGS. 10A to 10F illustrate an example of a user display screen and an administrator display screen according to the third embodiment of the present invention;

FIG. 11 is a third flow chart illustrating the flow of an information providing process according to the third embodiment of the present invention;

FIG. 12 is a fourth diagram illustrating an example of the functional configuration of the information providing unit according to a fourth embodiment of the present invention;

FIGS. 13A to 13F are a first diagram illustrating an example of an e-mail or message according to the fourth embodiment of the present invention;

FIGS. 14A and 14B are a second diagram illustrating an example of an e-mail or message according to the fourth embodiment of the present invention;

FIG. 15 is a fourth flow chart illustrating the flow of an information providing process according to the fourth embodiment of the present invention;

FIG. 16 is a diagram illustrating an application example of an information providing system according to a fifth embodiment of the present invention;

FIG. 17 is a third diagram illustrating an example of a system configuration of a network system according to a sixth embodiment of the present invention;

FIG. 18 is a fifth diagram illustrating an example of a functional configuration of an information providing unit according to the sixth embodiment of the present invention;

FIG. 19 is a fifth flow chart illustrating the flow of an information providing process according to the sixth embodiment of the present invention;

FIG. 20 is a fourth diagram illustrating an example of the system configuration of a network system according to a seventh embodiment of the present invention;

FIG. 21 is a sixth diagram illustrating an example of the functional configuration of an information providing unit according to the seventh embodiment of the present invention; and

FIG. 22 is a sixth flow chart illustrating the flow of an information providing process according to the seventh embodiment of the present invention.

### DESCRIPTION OF THE EMBODIMENTS

If the administrator of the conventional managing system responds by manually operating the managing system, when there are a large number of spaces to be managed, the burden on the administrator is high and it is difficult to respond quickly. Further, in the case of the conventional managing system, the measurement information measured by the sensor is provided to the users of the space through a user interface of the managing system, and in terms of the operation of the managing system, it is not realistic to reshape the user interface according to the requests of the users.

A problem to be addressed by an embodiment of the present invention is to provide a mechanism for providing the measurement information measured by the managing system to the users in cooperation with the managing system.

Each embodiment will be described below with reference to the accompanying drawings. In the present specification and drawings, with respect to elements having substantially the same functional configuration, duplicate descriptions will be omitted by assigning identical symbols.

### First Embodiment

### <System Configuration of Network System>

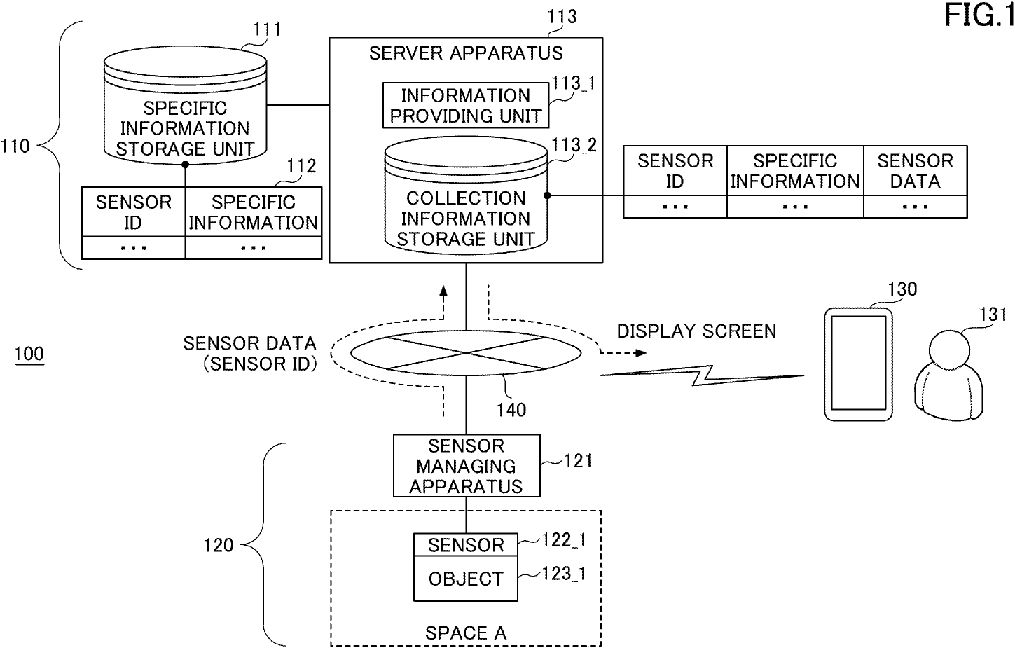

First, the system configuration of the entire network system including an information providing system according to the first embodiment will be described. FIG. 1 is a first diagram illustrating an example of the system configuration of the network system. As illustrated in FIG. 1, a network system 100 includes an information providing system 110, a first managing system 120, and a terminal 130. In the network system 100, a server apparatus 113 of the information providing system 110 a sensor managing apparatus 121 of the first managing system 120 are communicably connected through a network 140. In the network system 100, the server apparatus 113 of the information providing system 110 and the terminal 130 are communicatively connected through a network 140.

The information providing system 110 includes a specific information storage unit 111 and the server apparatus 113. The specific information storage unit 111 stores a table 112 in which a sensor ID (identification information) of a sensor described later is associated with specific information for identifying the resource where the sensor is installed. In the example of FIG. 1, the specific information storage unit 111 is provided outside the server apparatus 113, but the specific information storage unit 111 may be provided inside the server apparatus 113.

An information providing program is installed in the server apparatus 113, and when the program is executed, the server apparatus 113 functions as an information providing unit 113_1. The information providing unit 113_1 receives sensor data (an example of measurement information) transmitted from the first managing system 120 and the sensor ID of the sensor that has measured the sensor data. The sensor ID may be a mode included in the sensor data. Further, the information providing unit 113_1 associates the received sensor data with specific information based on the sensor ID and stores the sensor data in a collection information storage unit 113_2.

Further, the information providing unit 113_1 generates a display screen (an example of environment information) based on the sensor data and the specific information stored in the collection information storage unit 113_2. Further, the information providing unit 113_1 provides the generated display screen to the terminal 130 in response to an output request from the terminal 130. That is, the information providing unit 113_1 performs an information providing service with respect to the terminal 130.

The first managing system 120 includes the sensor managing apparatus 121 and a sensor 122_1. The sensor managing apparatus 121 is connected to the sensor 122_1, acquires sensor data measured by the sensor 122_1, and transmits the sensor data to the server apparatus 113 upon attaching the sensor ID (identification information) of the sensor 122_1 to the sensor data. The sensor 122_1 is installed on an object 123_1 in a space A, and measures the environment in a space A. In the example of FIG. 1, only one first managing system 120 is described for the sake of simplification, but there may be more than one first managing system 120. Alternatively, there may be more than one space for which the environment is to be measured in the first managing system 120.

The sensor 122_1 may be of any type, and the sensor 122_1 may be, for example, a sensor for measuring the air temperature, a sensor for measuring the humidity, or a sensor for measuring the carbon dioxide concentration. Alternatively, the sensor 122_1 may be a sensor for measuring the airflow, a sensor for measuring the dust amount, a sensor for measuring odor, a sensor for measuring sound volume, a sensor for measuring illuminance, etc.

Further, the space A may be various spaces (for example, a meeting room, a guest room, a store, a classroom, a building, a room, a venue, etc.) in an architectural structure (for example, an office building, accommodation, a commercial facility, an educational facility, a factory, a residence, an entertainment facility, etc.). Alternatively, the space A may be a space in a vehicle (for example, a car, a train car, etc.).

Further, the object 123_1 may be of any type and may be, for example, a ceiling, a floor, a sidewall, a window, etc., forming a space, as well as a specific object (for example, a chair, a desk, etc.) placed in the space. That is, the object 123_1 indicates the position of sensor 122_1 in the space A.

In the present embodiment, the concept including a space and an object is referred to as a “resource”, and the information for identifying the resource (for example, a meeting room in an office building, the ceiling of the meeting room) is referred to as “specific information”.

The terminal 130 is a terminal operated by a user using the space A. The terminal 130 makes an output request to the information providing unit 113_1 with respect to the display screen generated with respect to the space A, and displays the display screen provided by the information providing unit 113_1 in response to the output request.

Accordingly, a user 131 can identify the environment in the space A in real time, and depending on the identified environment in the space A, the user 131 can take measures to improve the environment. For example, suppose that the space A is a meeting room in an office building, and the sensor 122_1 is a sensor for measuring the carbon dioxide concentration. In such a case, if the carbon dioxide concentration displayed on the display screen exceeds a reference value (if a predetermined condition is satisfied), the user 131 can take measures such as opening the window of the meeting room.

Thus, according to the information providing system 110 according to the first embodiment, a mechanism for providing sensor data measured in the first managing system 120 to the user 131 of the space A in cooperation with the first managing system 120, can be provided.

### <Hardware Configuration of Server Apparatus>

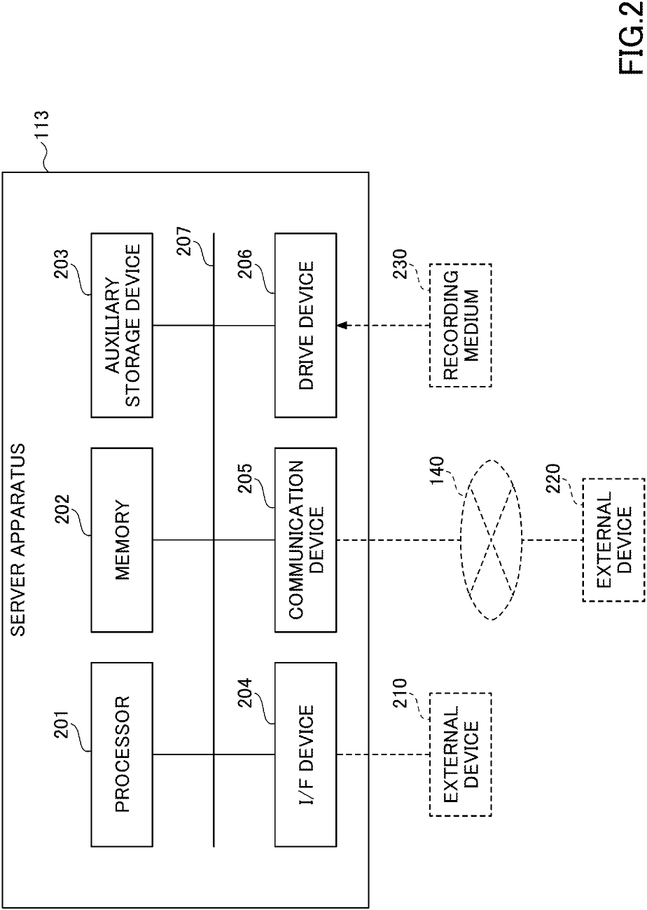

Next, the hardware configuration of the server apparatus 113 will be described. FIG. 2 illustrates an example of the hardware configuration of the server apparatus.

As illustrated in FIG. 2, the server apparatus 113 includes a processor 201, a memory 202, an auxiliary storage device 203, an interface (I/F) device 204, a communication device 205, and a drive device 206. The pieces of hardware included in the server apparatus 113 are connected to each other via a bus 207.

The processor 201 includes various computing devices such as a CPU (Central Processing Unit) and a GPU (Graphics Processing Unit). The processor 201 reads various programs (for example, information providing programs) into the memory 202 and executes the programs.

The memory 202 has a main storage device such as ROM (Read Only Memory) and RAM (Random Access Memory). The processor 201 and the memory 202 form what is referred to as a computer, and when the processor 201 executes various programs read on the memory 202, the computer implements various functional units.

The auxiliary storage device 203 stores various programs and various kinds of data used when various programs are executed by the processor 201. For example, the collection information storage unit 113_2 is implemented by the auxiliary storage device 203.

The I/F device 204 is a connecting device connected to an external device 210 (an operation device, a display device, the specific information storage unit 111, etc.). The I/F device 204 receives an operation with respect to the server apparatus 113 from an operator via the operation device. Further, the I/F device 204 outputs the result of processing and displays the result to the operator of the server apparatus 113 via the display device. Furthermore, the I/F device 204 transmits and receives various information to and from the specific information storage unit 111.

The communication device 205 is a communication device for communicating with an external device 220 (such as other devices in the network system 100) through the network 140. Specifically, the communication device 205 communicates with the sensor managing apparatus 121, the terminal 130, etc., through the network 140.

The drive device 206 is a device for setting a recording medium 230. The recording medium 230 here includes media for recording information optically, electrically, or magnetically, such as a compact disc read-only memory (CD-ROM), a flexible disk, a magneto-optical disk, etc. The recording medium 230 may also include a semiconductor memory, etc., for electrically recording information, such as a read-only memory (ROM), a flash memory, etc.

Various programs installed in the auxiliary storage device 203 are installed, for example, when the distributed recording medium 230 is set in the drive device 206 and various programs recorded in the recording medium 230 are read by the drive device 206. Alternatively, various programs installed in the auxiliary storage device 203 may be installed by being downloaded from the network 140 via the communication device 205.

### <Functional Configuration of the Information providing unit>

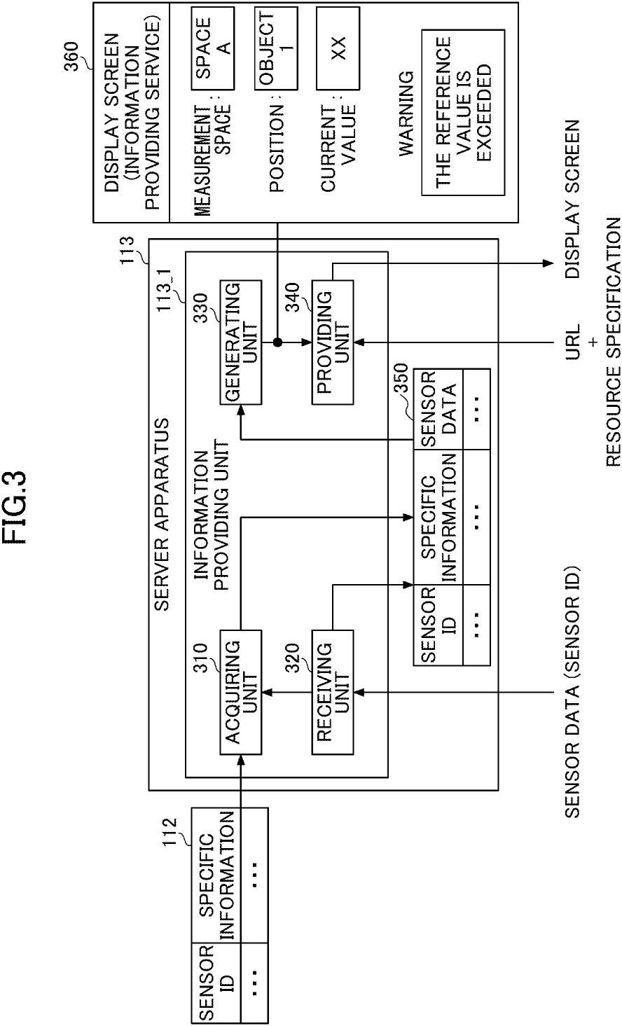

Next, the functional configuration of the information providing unit 113_1 will be described. FIG. 3 is a first diagram illustrating an example of the functional configuration of the information providing unit.

As illustrated in FIG. 3, the information providing unit 113_1 includes an acquiring unit 310, a receiving unit 320, a generating unit 330, and a providing unit 340.

Among these, the acquiring unit 310 reads, from the specific information storage unit 111, a table 112 in which the sensor ID (identification information) of the sensor 122_1 is associated with specific information (an object 123_1 in the space A) for specifying the resource where the sensor 122_1 is installed.

The receiving unit 320 receives the sensor data and the sensor ID (sensor ID of the sensor 122_1) transmitted from the sensor managing apparatus 121 of the first managing system 120.

The acquiring unit 310 acquires specific information corresponding to the sensor data by referring to the read table 112 based on the sensor ID received by the receiving unit 320. Further, the acquiring unit 310 associates the acquired specific information with the sensor data received by the receiving unit 320 and stores the specific information as a table 350 in a collection information storage unit 113_2.

The generating unit 330 reads the sensor data and the specific information from the table 350 stored in the collection information storage unit 113_2 and generates a display screen 360 (an example of environment information). Specifically, the generating unit 330 generates a display screen 360 for the resource (space name = space A) specified in the output request. Further, the generating unit 330 stores the generated display screen 360 with a URL corresponding to the resource (space name = space A) specified in the output request as a storage destination.

As illustrated in FIG. 3, the display screen 360 indicates which object in which space the sensor 122_1 has been installed (space name = space A, object name = object 1) and the value of the current sensor data (= XX) measured by the sensor 122_1 in the resource. Further, if the value of the current sensor data being displayed exceeds a predetermined reference value, a warning (characters or marks indicating a warning and/or characters indicating the content of the warning) is indicated on the display screen 360.

The providing unit 340 provides the display screen 360 reported by the generating unit 330 to the terminal 130 so that the display screen can be viewed through a web browser. Specifically, when the providing unit 340 receives, from the terminal 130, an output request (that is, an output request with a specified resource (space name = space A)) in which a URL indicating the storage destination of the display screen 360 is specified, the providing unit 340 provides the terminal 130 with the display screen 360 in which the URL is the storage destination. Thus, the user 131 operating the terminal 130 can visually view the display screen 360 generated with respect to the space A.

### <Flow of Information Providing Process>

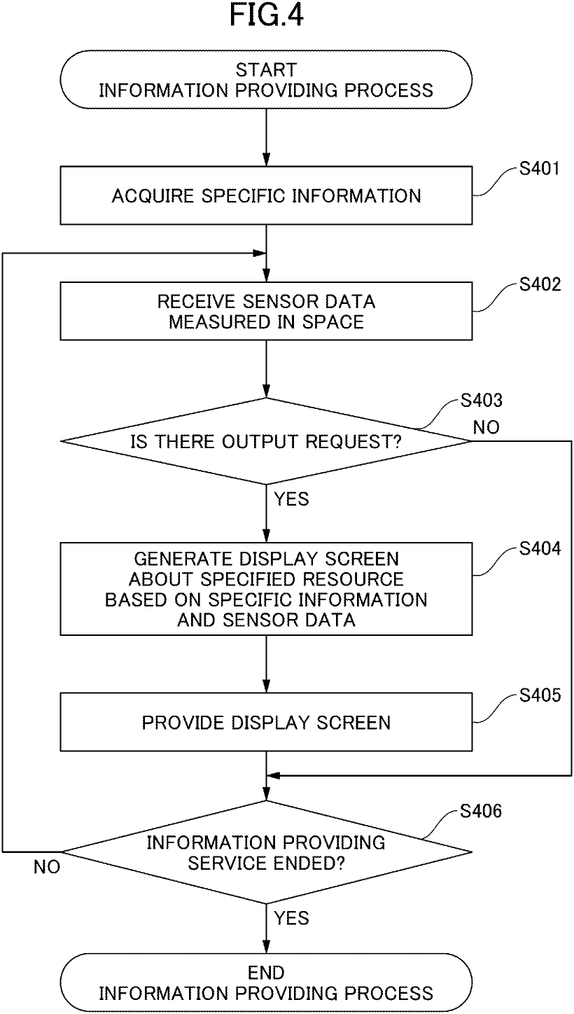

Next, the flow of the information providing process by the server apparatus 113 of the information providing system 110 according to the first embodiment will be described. FIG. 4 is a first flow chart illustrating the flow of an information providing process.

In step S401, the information providing unit 113_1 reads the table 112 from the specific information storage unit 111 and acquires the specific information associated with the sensor ID transmitted together with the sensor data. The timing at which the information providing unit 113_1 acquires the specific information may be any timing, for example, at a preset time or at preset intervals.

In step S402, the information providing unit 113_1 receives sensor data measured in the space A from the first managing system 120.

In step S403, the information providing unit 113_1 determines whether an output request specifying a resource (space A) has been received from the terminal 130. When it is determined in step S403 that no output request has been received (NO in step S403), the process proceeds to step S406. On the other hand, when it is determined in step S403 that an output request has been received (YES in step S403), the process proceeds to step S404.

In step S404, the information providing unit 113_1 generates environment information (the display screen 360) with respect to the resource (space A) specified in the output request, based on the acquired specific information and the received sensor data.

In step S405, the information providing unit 113_1 provides the generated display screen 360 to the terminal 130 via the network 140.

In step S406, the information providing unit 113_1 determines whether to end the information providing service. When it is determined in step S406 that the information providing service is to be continued (NO in step S406), the process returns to step S402. On the other hand, when it is determined in step S406 that the information providing service is to be ended (YES in step S406), the information providing process is ended.

### <Summary>

As is clear from the above description, the information providing system 110 according to the first embodiment performs the following procedures:
Connects, via the network 140, to the first managing system 120 managing the sensor data measured by the sensor 122_1.
Receives the sensor data and the sensor ID of the sensor 122_1 from the first managing system 120.
Acquires specific information corresponding to the received sensor data from the table 112 in which the sensor ID of the sensor 122_1 is associated with specific information (the object 123_1 in the space A) for specifying the resource where the sensor 122_1 is installed.
Generates the display screen 360 with respect to the resource (space name) specified in the output request, based on the acquired specific information and the received sensor data.
Provides the generated display screen 360 to the terminal 130 via the network 140.

Thus, according to the information providing system 110 according to the first embodiment, a mechanism for providing the sensor data measured in the managing system to the user in cooperation with the managing system, can be provided.

### Second Embodiment

In the first embodiment described above, the specific information storage unit 111 stores the table 112 for associating the sensor ID with the specific information, and the information providing unit 113_1 acquires the specific information from the specific information storage unit 111 based on the sensor ID.

However, the method of acquiring the specific information by the information providing unit 113_1 is not limited thereto, and the specific information may be acquired by other acquisition methods. Hereafter, the second embodiment will be described by focusing on the differences from the first embodiment.

### <System Configuration of Network System>

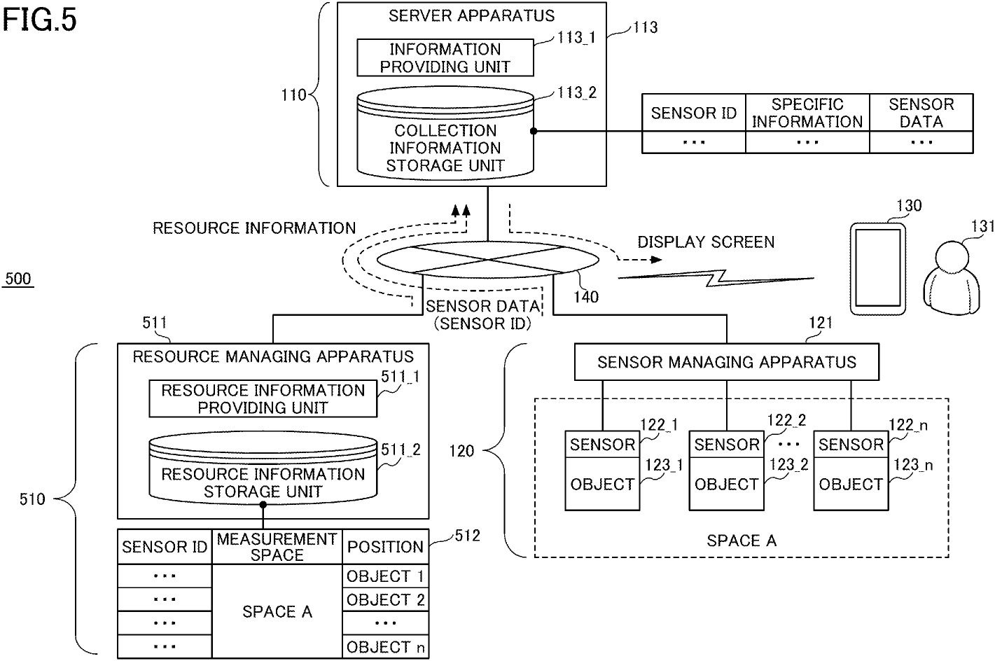

First, the system configuration of the entire network system including the information providing system according to the second embodiment will be described. FIG. 5 is a second diagram illustrating an example of the system configuration of the network system. The difference from the network system 100 illustrated in FIG. 1 is that a network system 500 illustrated in FIG. 5 includes a second managing system 510 instead of the specific information storage unit 111. Further, the difference from the network system 100 illustrated in FIG. 1 is that in the network system 500 illustrated in FIG. 5, there are multiple sensors 122_1 to 122_n in the space A, which are installed on objects 123_1 to 123_n, respectively.

As illustrated in FIG. 5, the second managing system 510 includes a resource managing apparatus 511. A resource information providing program is installed in the resource managing apparatus 511, and when the program is executed, the resource managing apparatus 511 functions as a resource information providing unit 511_1.

The resource information providing unit 511_1 reads the resource information of the space A, among the resource information 512 stored in the resource information storage unit 511_2, and transmits the resource information to the server apparatus 113. As illustrated in FIG. 5, the resource information 512 includes “sensor ID”, “measurement space”, and “position”, as items of information. Among these, the “sensor ID” stores identification information for identifying each of the sensors 122_1 to 122_n. The “measurement space” stores the space name of the space where each of the sensors 122_1 to 122_n is installed. The “position” stores the object name of each of the objects 123_1 to 123_n where one of the sensors 122_1 to 122_n is installed.

The sensor managing apparatus 121 is connected to each of the sensors 122_1 to 122_n, acquires sensor data measured by each of the sensors 122_1 to 122_n, and transmits the sensor data to the server apparatus 113 together with the corresponding sensor ID (identification information) of each of the sensors 122_1 to 122_n. The sensors 122_1 to 122_n are respectively installed on the objects 123_1 to 123_n in the space A, and measure the environment in the space A.

### <Functional Configuration of the Information providing unit>

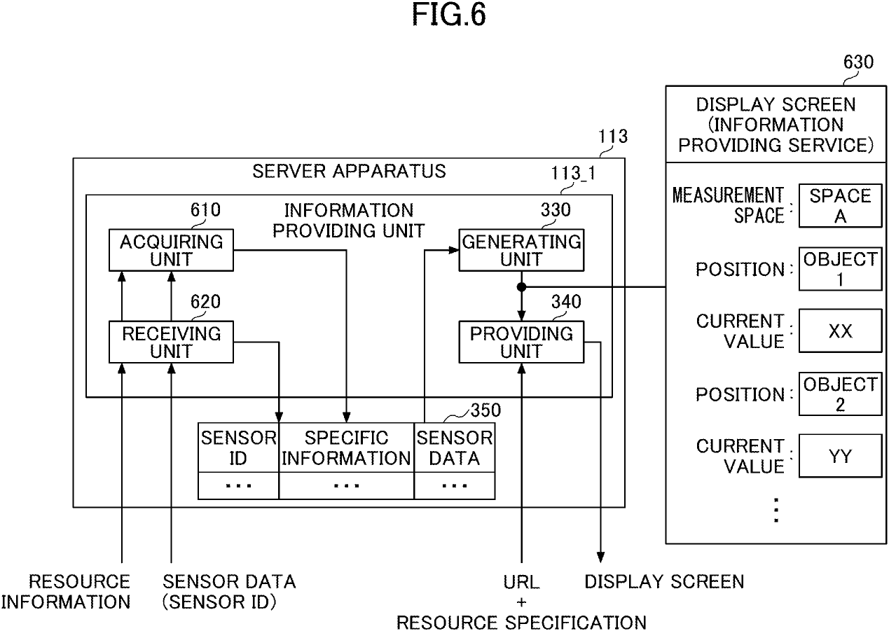

Next, the functional configuration of the information providing unit 113_1 will be described. FIG. 6 is a second diagram illustrating an example of the functional configuration of the information providing unit. The difference from the functional configuration of the information providing unit 113_1 illustrated in FIG. 3 is that in the case of the functional configuration of the information providing unit 113_1 illustrated in FIG. 6, the functions of an acquiring unit 610 and a receiving unit 620 are different from the functions of the acquiring unit 310 and the receiving unit 320 illustrated in FIG. 3.

The receiving unit 620 receives each piece of sensor data and each sensor ID (the sensor ID of each of the sensors 122_1 to 122_n) transmitted from the sensor managing apparatus 121 of the first managing system 120. Further, the receiving unit 620 receives resource information transmitted from the resource managing apparatus 511 of the second managing system 510.

Based on each sensor ID transmitted with each piece of sensor data, the acquiring unit 610 acquires each piece of specific information (object name of the object 123_1 to 123_n in the space A) corresponding to each sensor ID included in the resource information. Further, the acquiring unit 310 associates each piece of acquired specific information with each piece of sensor data received by the receiving unit 620 and stores the information as the table 350 in the collection information storage unit 113_2.

The generating unit 330 illustrated in FIG. 6 has the same function as the generating unit 330 illustrated in FIG. 3. However, in the case of the generating unit 330 illustrated in FIG. 6, because multiple sensors 122_1 to 122_n are installed in the space A, a display screen 630 including multiple pieces of sensor data (an example of environment information) is generated.

### <Examples of Display Screen>

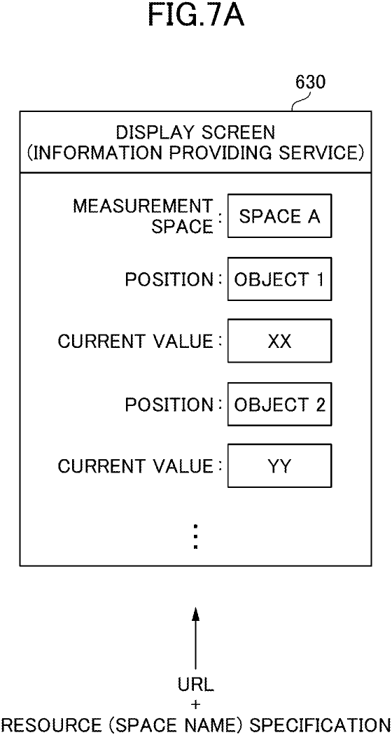

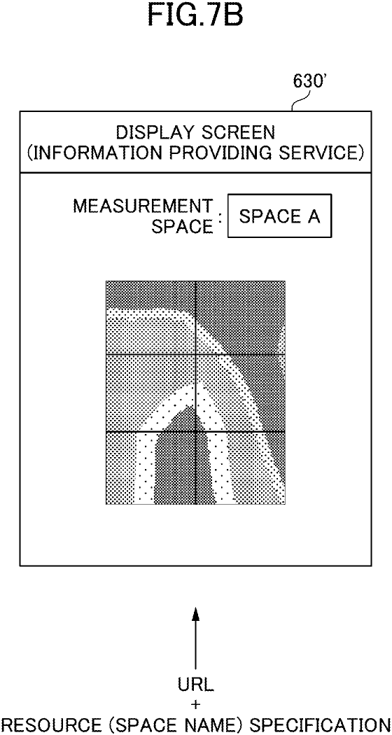

Next, specific examples of the display screen generated by the generating unit 330 will be described. FIGS. 7A to 7C illustrate examples of the display screen. Among these, the description of the display screen 630 in FIG. 7A is omitted here because the display screen 630 has already been described.

On the other hand, the display screen 630′ of FIG. 7B is a display screen when the data distribution in the space A is generated based on the sensor data measured by the multiple sensors 122_1 to 122_n installed in the space A. As illustrated in the display screen 630′, when multiple sensors are installed, the display screen 630′ can be generated by calculating the data distribution in the space A from the sensor data measured by each sensor and color-coding according to the calculation result.

Further, the display screen 630″ of FIG. 7C is a display screen generated based on the sensor data of the sensor installed in the specified resource when the terminal 130 specifies the resource (here, space name and object name) when making an output request. The example in FIG. 7C illustrates how the display screen 630″ is generated based on the sensor data of the sensor 122_2 installed on the object 123_2 in the space A when the object 123_2 in the space A (object name = object 2) is specified as the resource.

### <Flow of Information Providing Process>

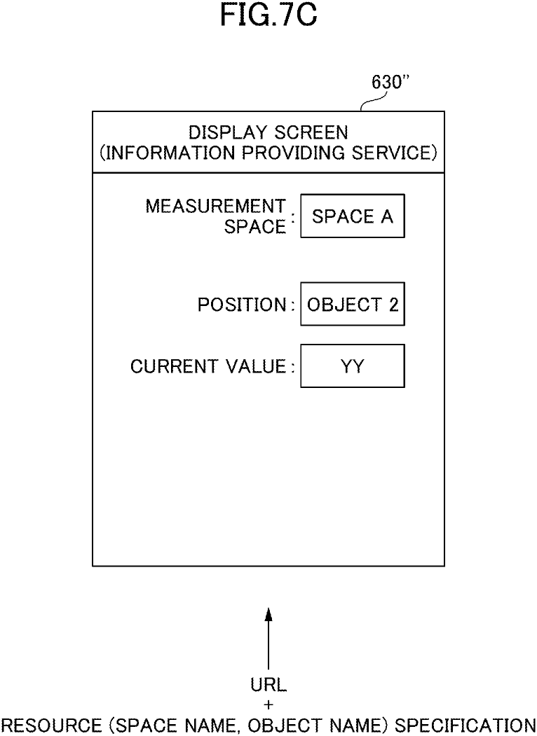

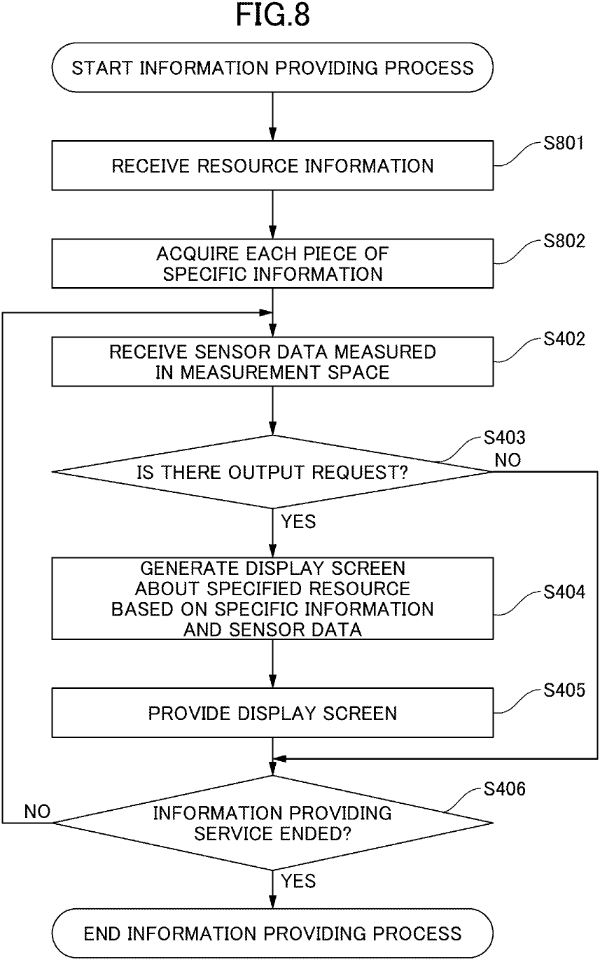

Next, the flow of an information providing process by the server apparatus 113 of the information providing system 110 according to the second embodiment will be described. FIG. 8 is a second flow chart illustrating the flow of an information providing process. The differences from the first flow chart illustrated in FIG. 4 are steps S801 and S802.

In step S801, the information providing unit 113_1 acquires the resource information of the space A from the resource managing apparatus 511 of the second managing system 510.

In step S802, the information providing unit 113_1 acquires each piece of specific information corresponding to each piece of sensor data based on each sensor ID included in the resource information.

### <Summary>

As is clear from the above description, the information providing system 110 according to the second embodiment performs the following procedures:
Connects, via the network 140, to the first managing system 120 that manages each piece of sensor data measured by sensors 122_1 to 122_n.
Receives each piece of sensor data and each sensor ID of the sensors 122_1 to 122_n from the first managing system 120.
Acquires resource information from the second managing system 510, and each piece of specific information corresponding to each piece of received sensor data based on each sensor ID included in the resource information.
Generates, based on each piece of acquired specific information and each piece of received sensor data, the display screen 630 or the like with respect to the resource (space name, object name) specified in the output request.
Provides the generated display screen 630 or the like to the terminal 130 via the network 140.

Thus, according to the second embodiment, even when the method of acquiring the specific information is changed, the same effect as the first embodiment can be attained.

### Third Embodiment

In the second embodiment described above, the user operating the terminal 130 is the user 131 using the space A. However, the attributes of the user operating the terminal 130 are not limited thereto. If an attribute of a user operating the terminal 130 varies, the provided display screen may be switched. Hereafter, the third embodiment will be described by focusing on the differences from the second embodiment.

### <Functional Configuration of the Information providing unit>

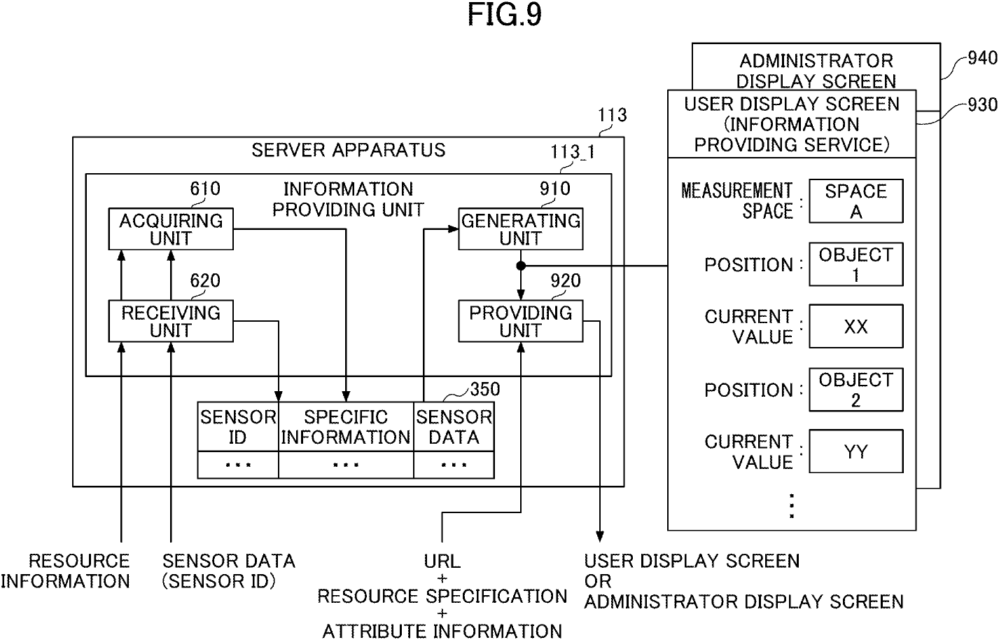

First, the functional configuration of the information providing unit 113_1 included in the server apparatus 113 of the information providing system 110 according to the third embodiment will be described. FIG. 9 is a third diagram illustrating an example of the functional configuration of the information providing unit. The difference from the functional configuration of the information providing unit 113_1 illustrated in FIG. 6 is that in the case of the functional configuration of the information providing unit 113_1 illustrated in FIG. 9, the functions of a generating unit 910 and a providing unit 920 are different from the functions of the generating unit 330 and the providing unit 340 illustrated in FIG. 6.

The generating unit 910 reads each piece of sensor data and each piece of specific information from the table 350 stored in the collection information storage unit 113_2, and generates the following:
A display screen with respect to the resource (space name = space A) specified in the output request,
that is, either a user display screen 930 or an administrator display screen 940.

The user display screen 930 is the display screen described using FIGS. 7A to 7C, etc., and is a display screen for a user who uses the space A. On the other hand, the administrator display screen 940 is a display screen for the administrator who manages the space A (or the administrator who manages the first managing system 120). Whether the user display screen 930 or the administrator display screen 940 is generated depends on whether “user” or “administrator” is selected as attribute information when an output request is received.

The providing unit 920 provides the terminal 130 with either the user display screen 930 or the administrator display screen 940 reported by the generating unit 910 so that the corresponding display screen can be viewed via a web browser. Specifically, the providing unit 920 provides the user display screen 930 generated by the generating unit 910 to the terminal 130, in the following case:
An output request (that is, an output request with a specified resource (space name = space A)) in which a URL indicating the storage destination of the user display screen 930 and the administrator display screen 940 is specified, is received from the terminal 130, and
“user” is selected as attribute information by the terminal 130.
In this case, the user operating the terminal 130 can visually view the user display screen 930.

On the other hand, the providing unit 920 provides the administrator display screen 940 generated by the generating unit 910 to the terminal 130, in the following case:
An output request (that is, an output request with a specified resource (space name = space A)) in which a URL indicating the storage destination of the user display screen 930 and the administrator display screen 940 is specified, is received from the terminal 130, and
“administrator” is selected as the attribute information by the terminal 130.
In this case, the administrator operating the terminal 130 can visually view the administrator display screen 940.

Thus, by allowing the administrator to visually view the administrator display screen 940 by operating the terminal 130, according to the information providing system 110 according to the third embodiment, it is unnecessary for the administrator to constantly monitor the space A. In addition, no configuration is required for the administrator to constantly monitor Space A.

### <Specific Examples of User Display Screens And administrator display screens>

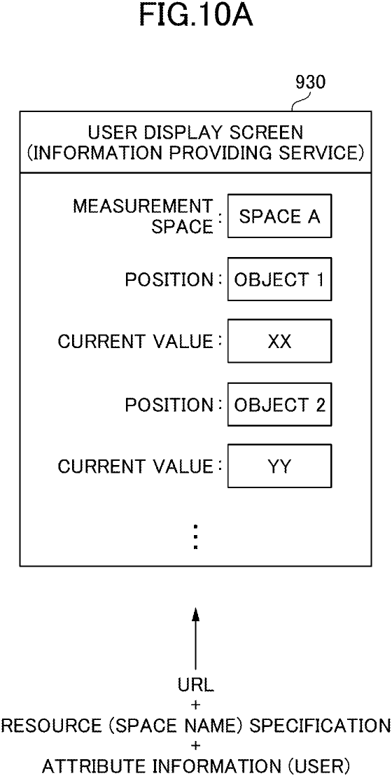

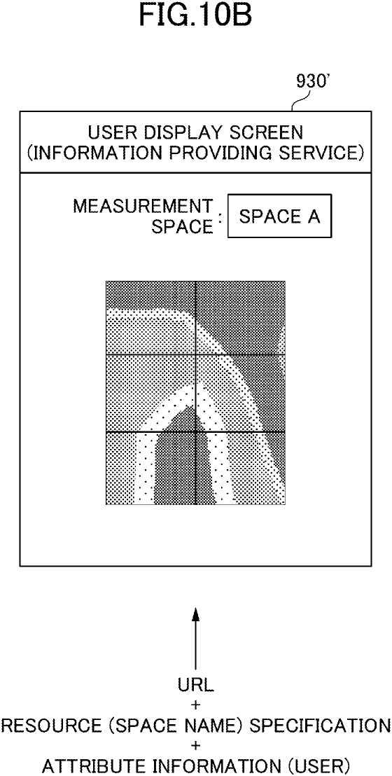

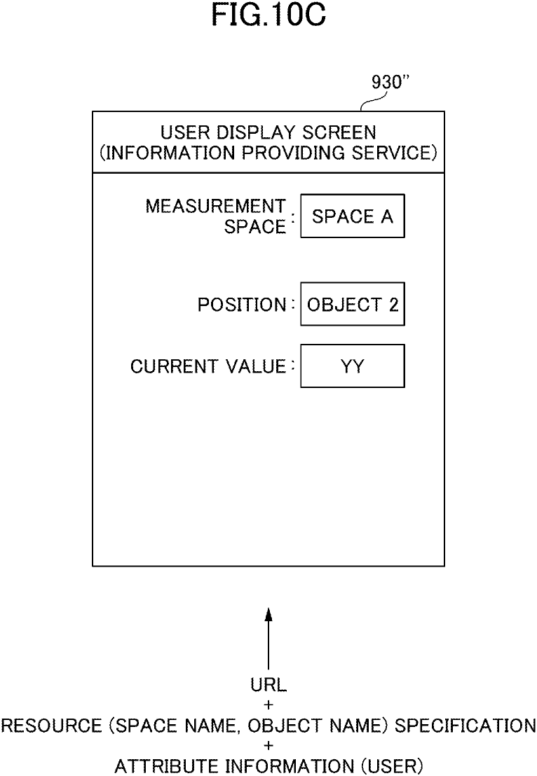

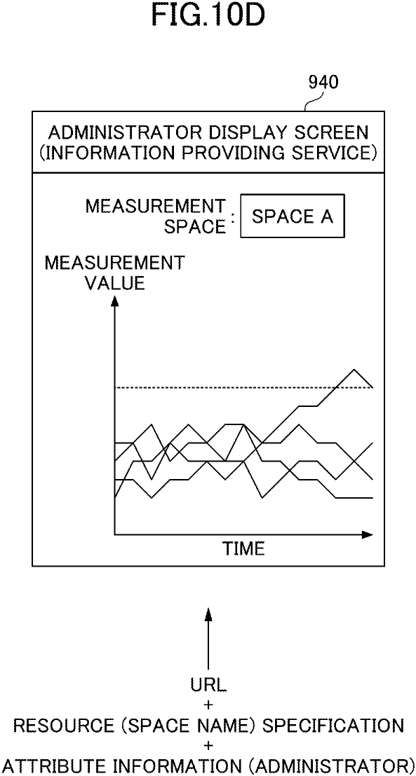

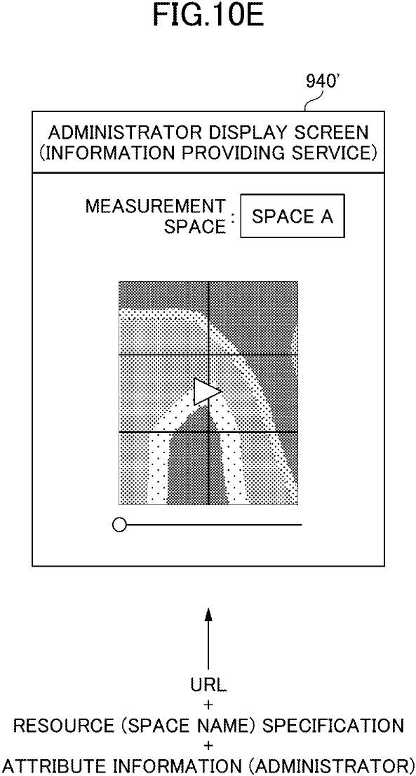

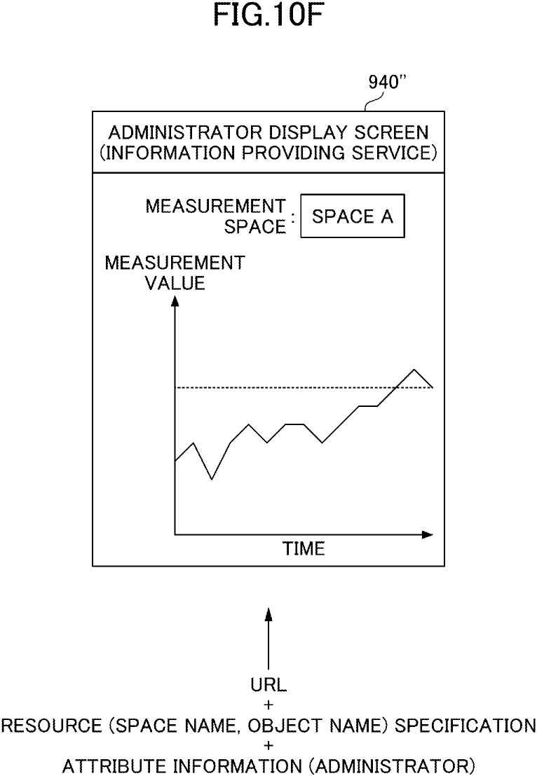

Next, specific examples of a user display screen and an administrator display screen generated by the generating unit 910 will be described. FIGS. 10A to 10F illustrate examples of a user display screen and an administrator display screen.

Among these, the user display screens 930 to 930″ of FIGS. 10A to 10C are the same as the display screens 630 to 630″ in FIGS. 7A to 7C, and, therefore, explanations thereof are omitted here.

On the other hand, as illustrated in FIG. 10D, an administrator display screen 940 includes a transition graph which indicates the time change from the past to the present, which is generated based on each piece of sensor data measured by the sensors 122_1 to 122_n installed in the space A.

Further, an administrator display screen 940′ illustrated in FIG. 10E includes the transition data distribution (video), which is the data distribution in the space A and indicates the time change from the past to the present, generated based on each piece of sensor data measured by multiple sensors 122_1 to 122_n installed in the space A.

Further, an administrator display screen 940″ illustrated in FIG. 10F includes a transition graph, which indicates the time change from the past to the present, generated based on the sensor data of the sensor installed in the specified resource, when the terminal 130 specifies the resource (space name, object name) when making an output request.

### <Flow of Information Providing Process>

Next, the flow of an information providing process by the server apparatus 113 of the information providing system 110 according to the third embodiment will be described. FIG. 11 is a third flow chart illustrating the flow of an information providing process. The differences from the second flow chart illustrated in FIG. 8 are steps S1101, S1102, and S1103.

In step S1101, the information providing unit 113_1 identifies the selected attribute information.

In step S1102, the information providing unit 113_1 generates the following, based on the specific information and the sensor data:
Environment information with respect to the resource (space name, object name) specified in the output request,
that is, the environment information (the user display screen 930 or the like or the administrator display screen 940 or the like) according to the identified attribute information.

In step S1103, the information providing unit 113_1 provides the generated display screen (either the user display screen 930 or the like or the administrator display screen 940 or the like) to the terminal 130 via the network 140.

### <Summary>

As is clear from the above description, the information providing system 110 according to the third embodiment performs the following procedures:
Connects, via the network 140, to the first managing system 120 that manages each piece of sensor data measured by sensors 122_1 to 122_n.
Receives each piece of sensor data and each sensor ID of sensors 122_1 to 122_n from the first managing system 120.
Acquires resource information from the second managing system 510, and acquires each piece of specific information corresponding to each piece of received sensor data based on each sensor ID included in the resource information.
Based on each piece of acquired specific information and each piece of received sensor data, generates a display screen (the user display screen 930 or the like or the administrator display screen 940 or the like) according to the attribute information, which is a display screen with respect to the resource (space name, object name) specified in the output request.
Provides the generated display screen (the user display screen 930 or the like or the administrator display screen 940 or the like) to the terminal 130 via the network 140.

With this, according to the third embodiment, the same effect as the first and second embodiment can be attained, and different display screens can be provided according to the attributes of the user operating the terminal 130.

As a result, according to the third embodiment, a mechanism for providing sensor data measured in the managing system to the administrator managing the managing system in cooperation with the managing system, can be provided.

### Fourth Embodiment

In each of the above embodiments, it is explained that the user 131 confirms sensor data (in the event that the reference value is exceeded, a warning is further confirmed) in the space to be used by visually viewing the display screen through a web browser. However, the method by which the user 131 confirms sensor data, warnings, etc., is not limited thereto. For example, the server apparatus 113 may be configured to transmit sensor data, warnings, etc., to the terminal 130 via an e-mail application (app) or a messaging app. Thus, the user 131 can automatically receive and confirm sensor data, warnings, etc., without accessing the server apparatus 113 via a web browser. Hereafter, the fourth embodiment will be described by focusing on the differences from the above examples.

### <Functional Configuration of the Information providing unit>

First, the functional configuration of the information providing unit 113_1 included in the server apparatus 113 of the information providing system 110 according to the fourth embodiment will be described. FIG. 12 is a fourth diagram illustrating an example of the functional configuration of the information providing unit. The difference from the functional configuration of the information providing unit 113_1 illustrated in FIG. 6 is that in the functional configuration of the information providing unit 113_1 illustrated in FIG. 12, the functions of a generating unit 1210 and a providing unit 1220 are different from the functions of the generating unit 330 and the providing unit 340 illustrated in FIG. 6. The difference from the functional configuration of the information providing unit 113_1 illustrated in FIG. 6 is that in the functional configuration of the information providing unit 113_1 illustrated in FIG. 12, a registration unit 1230 is newly included.

The generating unit 1210 reads each piece of sensor data and each piece of specific information from the table 350 stored in the collection information storage unit 113_2 and generates an e-mail or a message 1240 (an example of environment information). Specifically, the generating unit 1210 generates an e-mail or message 1240 with respect to the resource specification information according to the registration contents to be described later at a timing according to the registered contents to be described later. The content of the e-mail or message 1240 is the same as that of the display screen 630 in FIG. 6.

The providing unit 1220 transmits the e-mail or message 1240 generated by the generating unit 1210 to the transmission destination via an e-mail app or a messaging app, etc. The transmission destination to which the providing unit 1220 transmits the e-mail or message 1240 is preregistered in the registration unit 1230. The transmission timing at which the providing unit 1220 transmits the e-mail or message 1240 is preregistered in the registration unit 1230. Further, the content of the e-mail or message 1240 transmitted by the providing unit 1220 is preregistered in the registration unit 1230.

The registration unit 1230 receives registration by the user 131 and reports the registered content to the generating unit 1210 and the providing unit 1220. The registered content received by the registration unit 1230 includes:
transmission destination information (for example, an e-mail address, an account),
transmission timing information (for example, once at a specified date and time, multiple times at a specified date and time, once daily for a specified time period, etc.), and
resource specification information and the like (for example, resource (space name, object name) specification information, specification information whether to transmit sensor data and/or warnings, etc.).

### <Specific Examples of E-mail or Message>

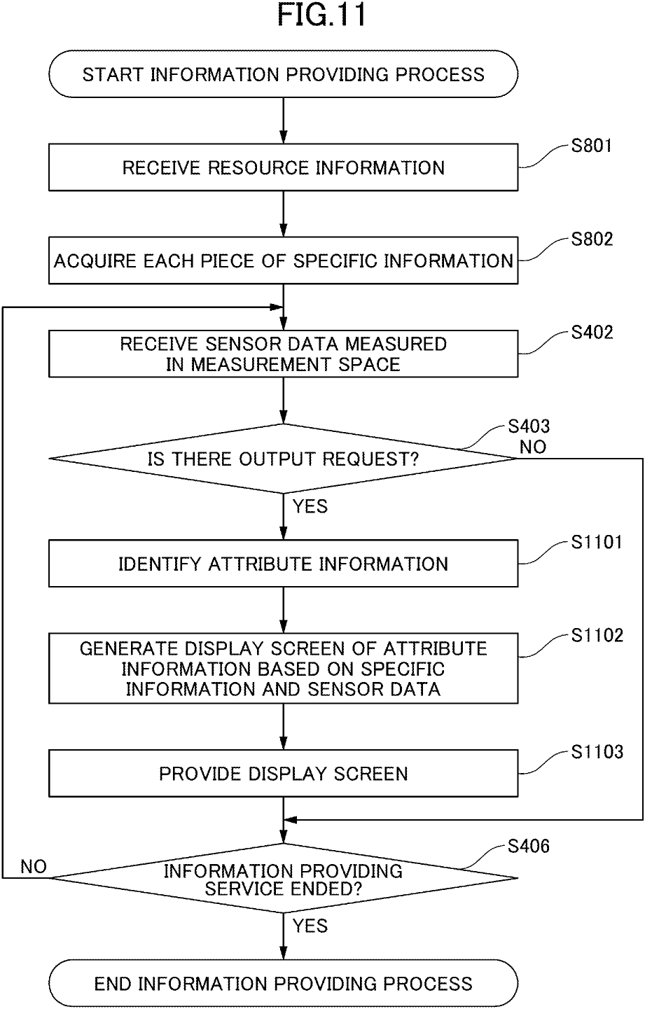

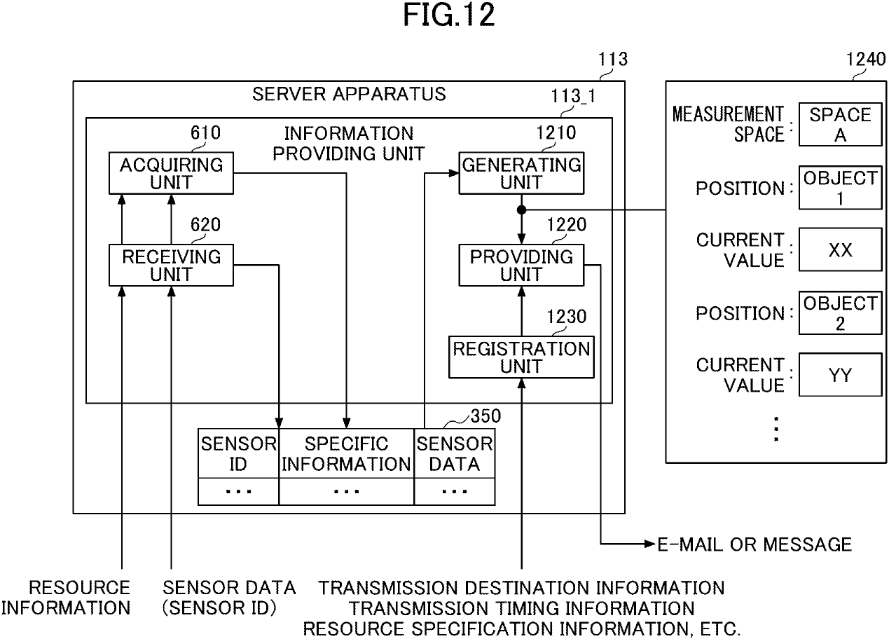

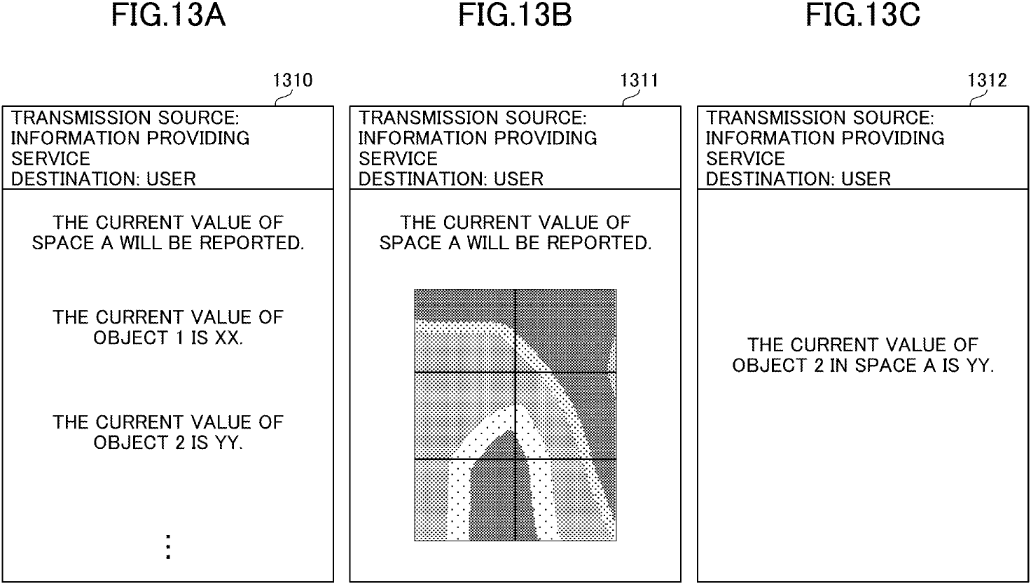

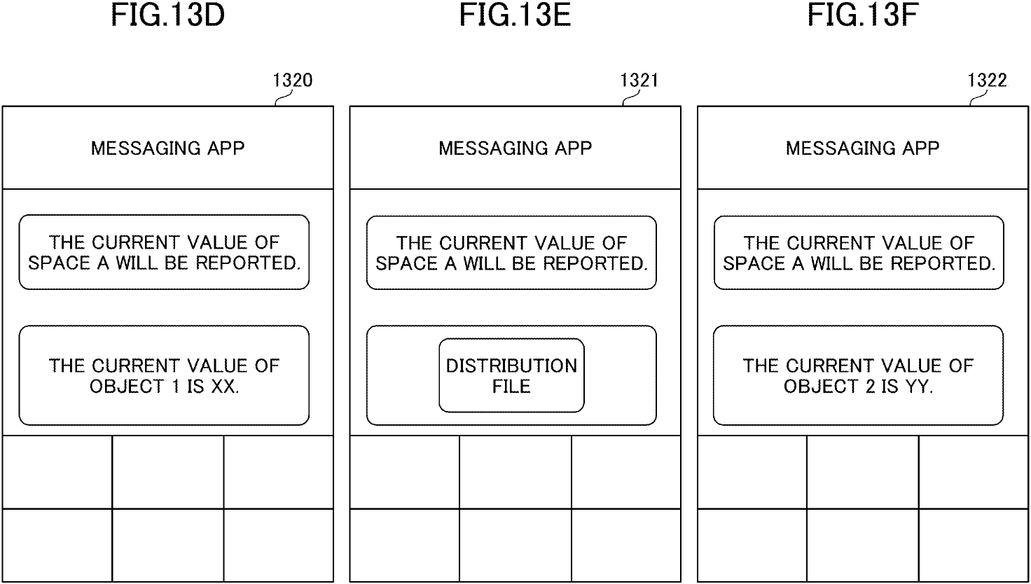

Next, specific examples of an e-mail or a message transmitted by the providing unit 1220 and displayed on the terminal 130 will be described. FIGS. 13A to 13F is a first diagram illustrating an example of the e-mail or message.

In FIG. 13A, an e-mail 1310 is an example of the e-mail received by the terminal 130 via the e-mail app while the user 131 is using the space A. The e-mail 1310 example illustrates that all of the current sensor data with respect to the space A has been transmitted via e-mail.

Similarly, an e-mail 1311 in FIG. 13B is an example of an e-mail with an attachment file received by the terminal 130 via the e-mail app while the user 131 is using the space A. The e-mail 1311 example illustrates that the data distribution generated based on all the current sensor data for space A has been attached to the e-mail.

Further, an e-mail 1312 in FIG. 13C is an example of the e-mail received by the terminal 130 via the e-mail app while the user 131 is using the space A, which includes only the sensor data of the sensor installed at the specified resource. The example of the e-mail 1312 illustrates that only the current sensor data of sensor 122_2 installed on object 123_2 in the space A has been transmitted by e-mail.

On the other hand, a message 1320 in FIG. 13D is an example of a message received by the terminal 130 via a messaging app while the user 131 is using the space A. The example of the message 1320 illustrates that all current sensor data for space A has been transmitted in a message.

Similarly, a message 1321 in FIG. 13E is an example of a message received by the terminal 130 via a messaging app while the user 131 is using the space A. The example of the message 1321 illustrates that a file of a data distribution generated based on all current sensor data for space A has been transmitted with the message.

Further, a message 1322 in FIG. 13F is an example of a message including only sensor data from a sensor installed at the specified resource that has been received by the terminal 130 via a messaging app while the user 131 is using the space A. The example of the message 1322 illustrates that the current sensor data of the sensor 122_2 installed at the object 123_2 in the space A has been transmitted in a message.

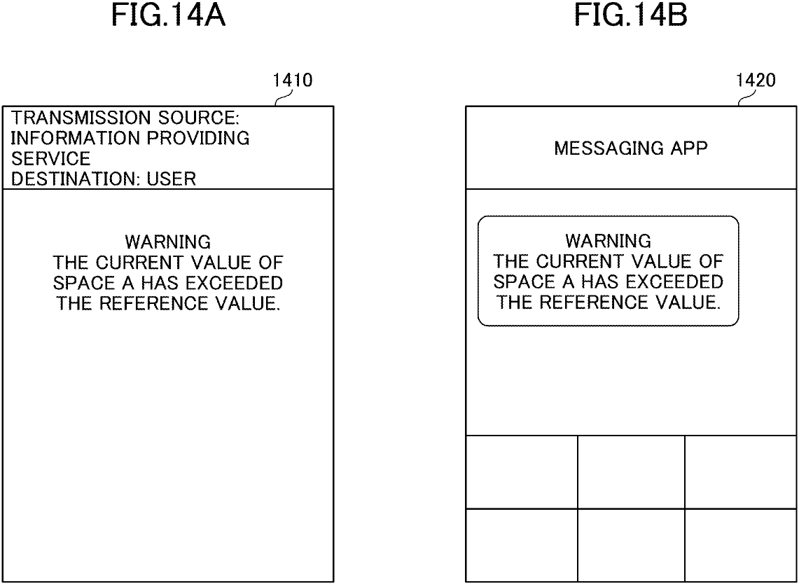

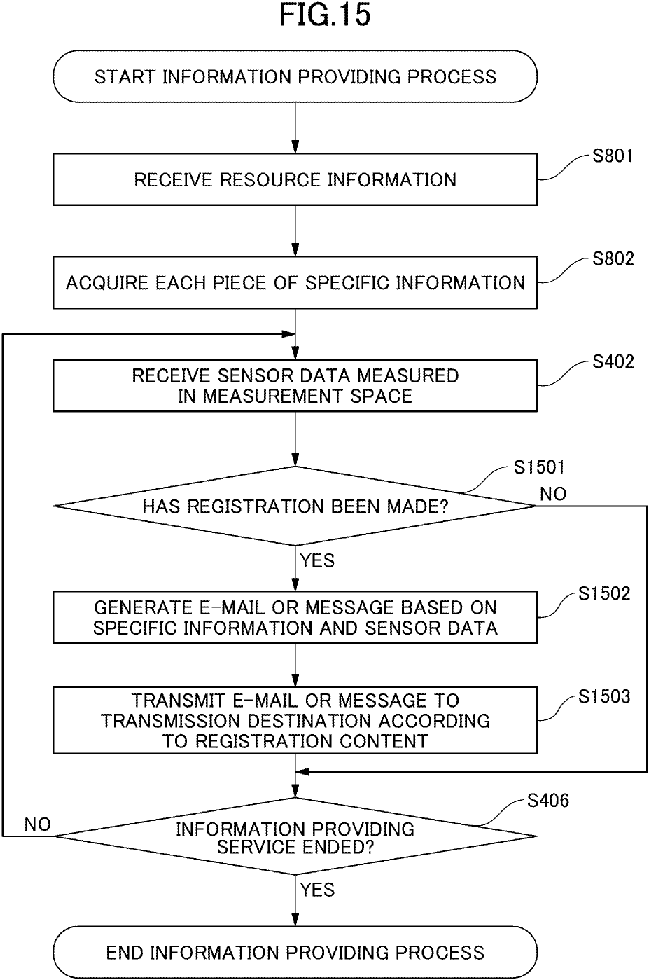

FIGS. 14A and 14B are second diagrams illustrating examples of an e-mail or message. In FIG. 14A, an e-mail 1410 is an example of a warning e-mail received by the terminal 130 because the sensor data has exceeded a reference value while the user 131 has been using the space A. The e-mail 1410 example illustrates that a warning has been transmitted when any of the pieces of sensor data in the space A has exceeded the reference value.

Further, in FIG. 14B, a message 1420 is an example of a warning message received by the terminal 130 because the sensor data has exceeded the reference value while the user 131 has been using the space A. The example of the message 1420 illustrates that a warning has been transmitted because any of the pieces of sensor data in the space A has exceeded the reference value.

Note that the warning may be included in the e-mail or message illustrated in FIGS. 13A to 13F or, as illustrated in FIGS. 14A and 14B, the warning may be included in a different e-mail or message from the e-mail or message illustrated in FIGS. 13A to 13F.

### <Flow of Information Providing Process>

Next, the flow of an information providing process by the server apparatus 113 of the information providing system 110 according to the fourth embodiment will be described. FIG. 15 is a fourth flow chart illustrating the flow of an information providing process. The difference from the second flow chart illustrated in FIG. 8 is steps S1501 to S1503.

In step S1501, the information providing unit 113_1 determines whether registration has been made by the user 131. When it is determined in step S1501 that registration has not been made by the user 131 (NO in step S1501), the process proceeds to step S406.

On the other hand, when it is determined in step S1501 that registration has been made by the user 131 (YES in step S1501), the process proceeds to step S1502.

In step S1502, based on the specific information and sensor data, the information providing unit 113_1 generates an e-mail or message with respect to the resource specification information according to the registered contents at a timing according to the registered contents.

In step S1503, the information providing unit 113_1 transmits an e-mail or message to the transmission destination according to the registered contents at a timing according to the registered contents.

### <Summary>

As is clear from the above description, the information providing system 110 according to the fourth embodiment has the same configuration as those of the above examples, and performs the following procedures:
Based on each piece of the acquired specific information and each piece of the received sensor data, generates an e-mail or message to be transmitted to the terminal 130, with respect to the resource specification information according to the registered contents, at a timing according to the registered contents registered in advance.
At a timing according to the registered contents registered in advance, transmits the generated e-mail or message to the transmission destination according to the registered contents.

With this, according to the fourth embodiment, the same effect as the above respective embodiments can be attained. Further, according to the fourth embodiment, the user can automatically receive environment information (including warnings) via an e-mail app, a messaging app, etc., without accessing a server apparatus via a web browser.

### Fifth Embodiment

Specific examples of sensors, specific examples of spaces, and specific examples of users and administrators have not been specified in each of the above embodiments. Therefore, in the fifth embodiment, application examples of the information providing system 110 are indicated, and specific examples of sensors, specific examples of spaces, specific examples of users and administrators, etc. are explained.

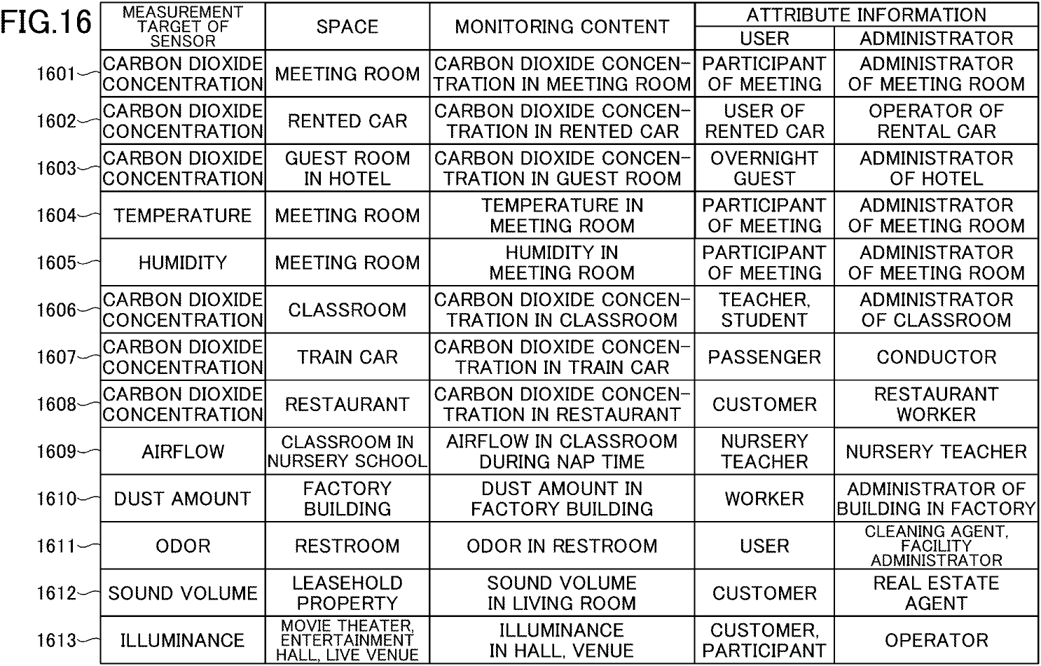

FIG. 16 illustrates application examples of the information providing system. As an application example of the information providing system 110 described in each of the above embodiments, for example, the application examples illustrated in FIG. 16 are assumed.

In FIG. 16, a reference numeral 1601 indicates a case where the information providing system 110 is applied to monitoring the carbon dioxide concentration in each meeting room in an office building. In such an application case, measurement target of the sensor = carbon dioxide concentration, space = meeting room, user = meeting participant, administrator = meeting room administrator.

In FIG. 16, a reference numeral 1602 denotes a case where the information providing system 110 is applied to the monitoring of carbon dioxide concentration in a rented car. In such an application case, measurement target of sensor = carbon dioxide concentration, space = rented car, user = rented car user, and administrator = rented car operator.

Further, in FIG. 16, a reference numeral 1603 indicates a case where the information providing system 110 is applied to the monitoring of carbon dioxide concentration in a guest room in a hotel. In such an application case, measurement target of sensor = carbon dioxide concentration, space = guest room of hotel, user = overnight guest, and administrator = hotel administrator.

Further, in FIG. 16, a reference numeral 1604 indicates that the information providing system 110 is applied to monitoring the temperature in each meeting room in an office building. In such an application case, measurement target of sensor = temperature, space = meeting room, user = meeting participant, and administrator = meeting room administrator.

In FIG. 16, a reference numeral 1605 indicates that the information providing system 110 is applied to the monitoring of humidity in each meeting room in an office building. In such an application case, measurement target of sensor = humidity, space = meeting room, user = meeting participant, and administrator = meeting room administrator.

Further, in FIG. 16, a reference numeral 1606 indicates that the information providing system 110 is applied to the monitoring of the carbon dioxide concentration in the classroom of an educational facility (such as a school). In such an application case, measurement target of sensor = carbon dioxide concentration, space = classroom, user = teacher, student, and administrator = administrator of classroom.

Further, in FIG. 16, a reference numeral 1607 indicates a case where the information providing system 110 is applied to the monitoring of the carbon dioxide concentration in a train car. In such an application case, measurement target of sensor = carbon dioxide concentration, space = train car, user = passenger, and administrator = conductor.

In FIG. 16, a reference numeral 1608 denotes a case where the information providing system 110 is applied to monitoring the carbon dioxide concentration in a restaurant. In such an application case, measurement target of sensor = carbon dioxide concentration, space = restaurant, user = customer, and administrator = restaurant worker.

Further, in FIG. 16, a reference numeral 1609 indicates that the information providing system 110 is applied to the monitoring of the airflow in the classroom of the nursery school during nap time. In such an application case, measurement target of sensor = airflow, space = classroom of nursery school, user = nursery teacher, and administrator = nursery teacher.

Further, in FIG. 16, a reference numeral 1610 indicates that the information providing system 110 is applied to the monitoring of the amount of dust in a factory building. In such an application case, measurement target of sensor = amount of dust, space = factory building, user = worker, and administrator = administrator of factory building.

Further, in FIG. 16, a reference numeral 1611 indicates a case where the information providing system 110 is applied to the monitoring of odors in a restroom. In such an application case, measurement target of sensor = odor, space = restroom, user = user, administrator = cleaning agent, facility administrator.

In FIG. 16, a reference numeral 1612 indicates that the information providing system 110 is applied to the monitoring of noise in a living room. In such an application case, measurement target of sensor = volume, space = living room of leasehold property, user = customer, administrator = real estate agent.

Further, in FIG. 16, a reference numeral 1613 indicates that the information providing system 110 is applied to the monitoring of the illuminance in a building or a venue. In such an application case, measurement target of sensor = illuminance, space = movie theater, entertainment hall, live venue, user = customer, participant, administrator = operator.

Thus, various application examples are assumed for the information providing system 110.

### Sixth Embodiment

In each of the above embodiments, the information providing system in which various application examples are assumed has been described. Accordingly, details of the application of the information providing system 110 to the monitoring of the carbon dioxide concentration in each meeting room in an office building are described below.

### <System Configuration of Network System>

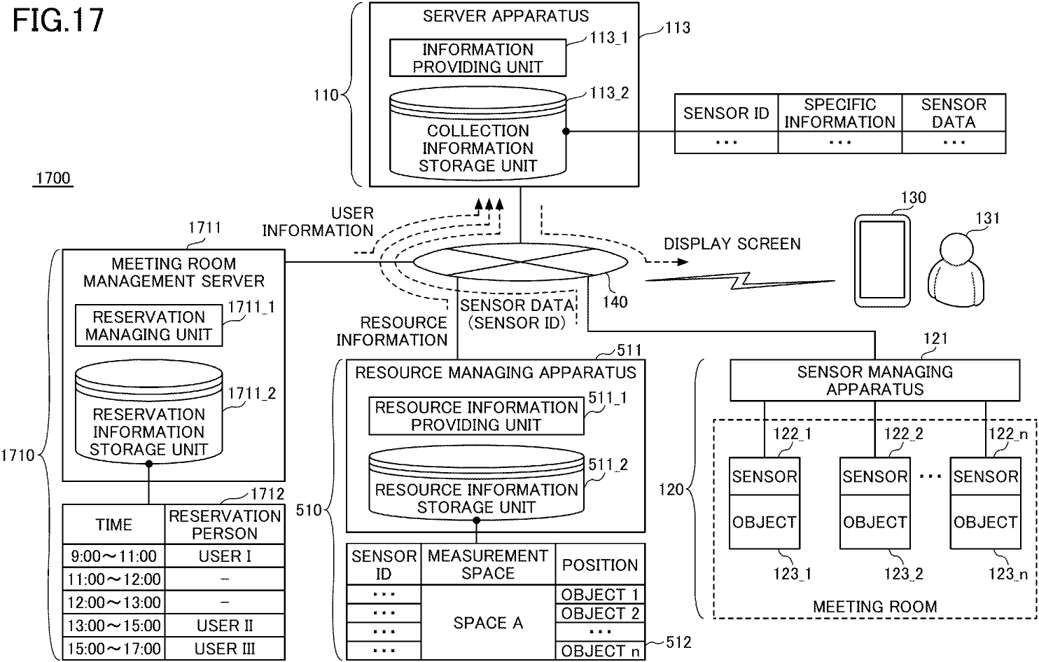

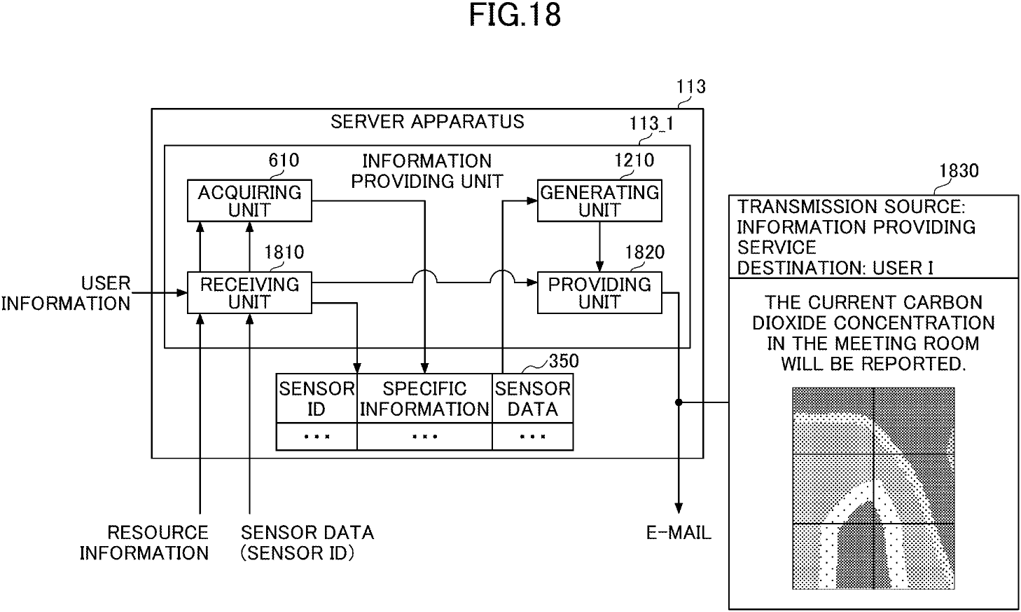

First, the system configuration of the entire network system including the information providing system according to the sixth embodiment will be described. FIG. 17 is a third diagram illustrating an example of the system configuration of the network system. The difference from the network system 500 illustrated in FIG. 5 is that a network system 1700 illustrated in FIG. 17 includes a third managing system 1710.

The third managing system 1710 includes a meeting room management server 1711. A reservation management program is installed in the meeting room management server 1711, and when the program is executed, the meeting room management server 1711 functions as a reservation managing unit 1711_1.

The reservation managing unit 1711_1 receives a reservation for a meeting room and registers the reservation in user information 1712 in a reservation information storage unit 1711_2. Further, the reservation managing unit 1711_1 reads the user information 1712 stored in the reservation information storage unit 1711_2 and transmits the user information 1712 to the server apparatus 113.

The user information 1712 illustrated in FIG. 17 is the user information of one predetermined meeting room, and as illustrated in FIG. 17, the user information 1712 includes “time” and “reservation person” as information items. Among these, “time” stores the usage time of using one predetermined meeting room. “Reservation person” stores the name of the user who uses the predetermined one meeting room during the corresponding usage time.

### <Functional Configuration of the Information providing unit>

Next, the functional configuration of the information providing unit 113_1 will be described. FIG. 18 is a fifth diagram illustrating an example of the functional configuration of the information providing unit. The difference from the functional configuration of the information providing unit 113_1 illustrated in FIG. 12 is that in the case of the functional configuration of the information providing unit 113_1 illustrated in FIG. 18, the functions of a receiving unit 1810 and a providing unit 1820 are different from the functions of the receiving unit 620 and the providing unit 1220 illustrated in FIG. 12. The difference from the functional configuration of the information providing unit 113_1 illustrated in FIG. 12 is that in the case of the functional configuration of the information providing unit 113_1 illustrated in FIG. 18, the registration unit 1230 is not provided.

The receiving unit 1810 receives each piece of sensor data and each sensor ID (each sensor ID of the sensors 122_1 to 122_n) transmitted from the sensor managing apparatus 121 of the first managing system 120. Further, the receiving unit 1810 receives resource information transmitted from the resource managing apparatus 511 of the second managing system 510. Further, the receiving unit 1810 receives user information 1712 transmitted from the meeting room management server 1711 of the third managing system 1710. Further, the receiving unit 1810 reports the received user information to the providing unit 1820.

The providing unit 1820 transmits the e-mail generated by the generating unit 1210 to the transmission destination via an e-mail app. The transmission destination to which the providing unit 1820 transmits the e-mail is determined based on the user information reported by the receiving unit 1810.

Specifically, the providing unit 1820 identifies the user whose usage time is a time that includes the current time, among the “time” stored in the user information. Further, the providing unit 1820 transmits an e-mail via the e-mail app with the e-mail address of the identified user as the transmission destination.

The providing unit 1820 transmits the e-mail generated by the generating unit 1210 (e-mail generated based on the predetermined content). Further, the providing unit 1820 transmits the e-mail at a predetermined transmission timing within the above usage time for the predetermined number of transmission times.

In FIG. 18, an e-mail 1830 illustrates the e-mail transmitted at the predetermined timing by the providing unit 1820 to the user 131 (user name = user I) who is currently using the meeting room with the data distribution generated based on all the sensor data in the meeting room attached.

### <Flow of Information Providing Process>

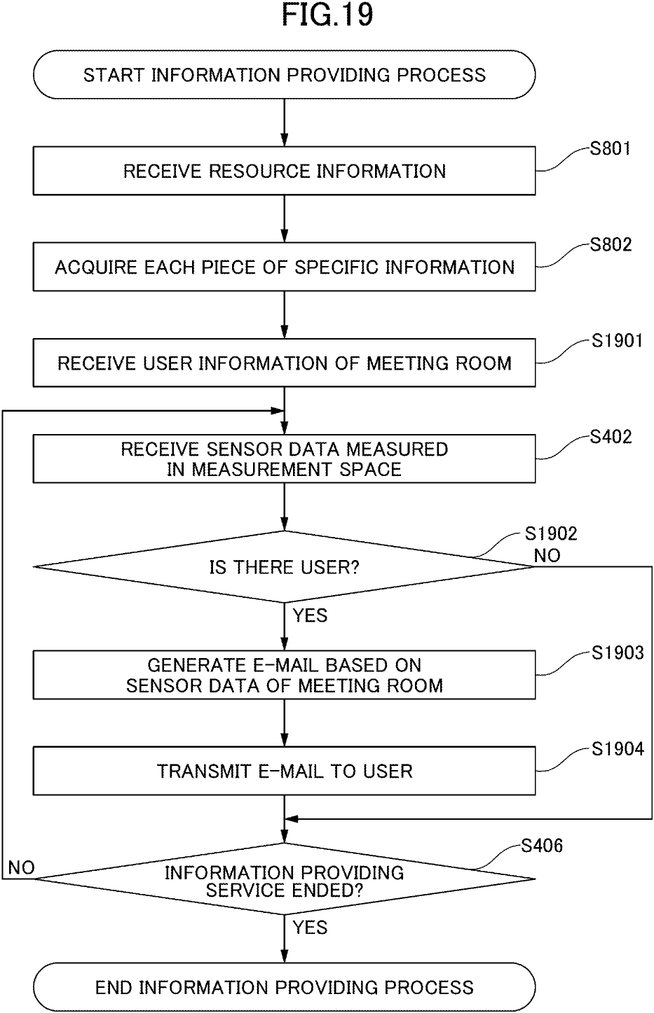

Next, the flow of an information providing process by the server apparatus 113 of the information providing system 110 according to the sixth embodiment will be described. FIG. 19 is a fifth flow chart illustrating the flow of an information providing process. The differences from the second flow chart illustrated in FIG. 8 are steps S1901 and S1902 to S1904.

In step S1901, the information providing unit 113_1 receives the user information of the meeting room from the third managing system 1710.

In step S1902, the information providing unit 113_1 determines whether there is a user of the meeting room at the current time. When it is determined in step S1902 that there is no user of the meeting room at the current time (NO in step S1902), the process proceeds to step S406.

On the other hand, if it is determined in step S1902 that there is a user of the meeting room at the current time (YES in step S1902), the process proceeds to step S1903.

In step S1903, the information providing unit 113_1 generates an e-mail based on the specific information indicating the object on which the sensor is installed in the meeting room and the sensor data.

In step S1904, the information providing unit 113_1 transmits the generated e-mail to the e-mail address of the user.

### <Summary>

As is clear from the above description, the information providing system 110 according to the sixth embodiment performs the following procedures in addition to the fourth embodiment described above:
Receives the user information from third managing system and, based on the received user information, identifies the reservation person at the current time (the user who is currently using the meeting room).
Transmits the e-mail to the e-mail address of the identified user.

Thus, according to the sixth embodiment, the same effect as the fourth embodiment can be attained. Further, according to the sixth embodiment, the user does not need to register the transmission destination information in advance in the server apparatus 113, which improves the user’s convenience.

### Seventh Embodiment

In the server apparatus 113 in the sixth embodiment above, the explanation is made assuming that the e-mail address of the user included in the user information 1712 is managed in advance. However, the server apparatus 113 does not need to manage the e-mail address of the user in advance, and may be configured to identify the e-mail address of the user by, for example, referring to a storage unit where the e-mail address of the user is managed in advance. Hereafter, the seventh embodiment will be described by focusing on the differences from the sixth embodiment.

### <System Configuration of Network System>

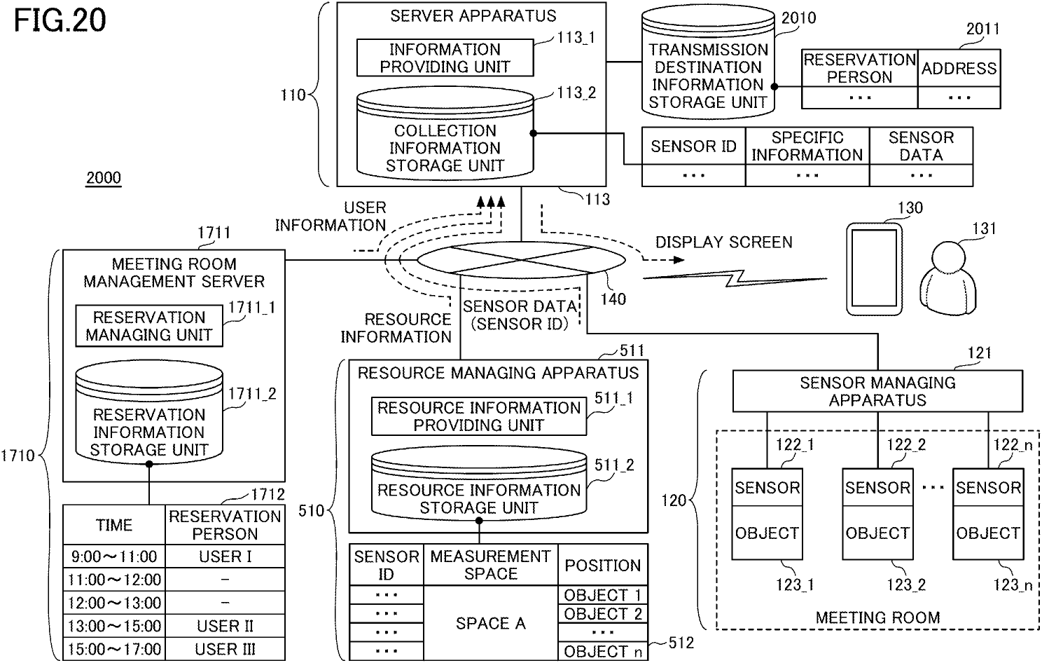

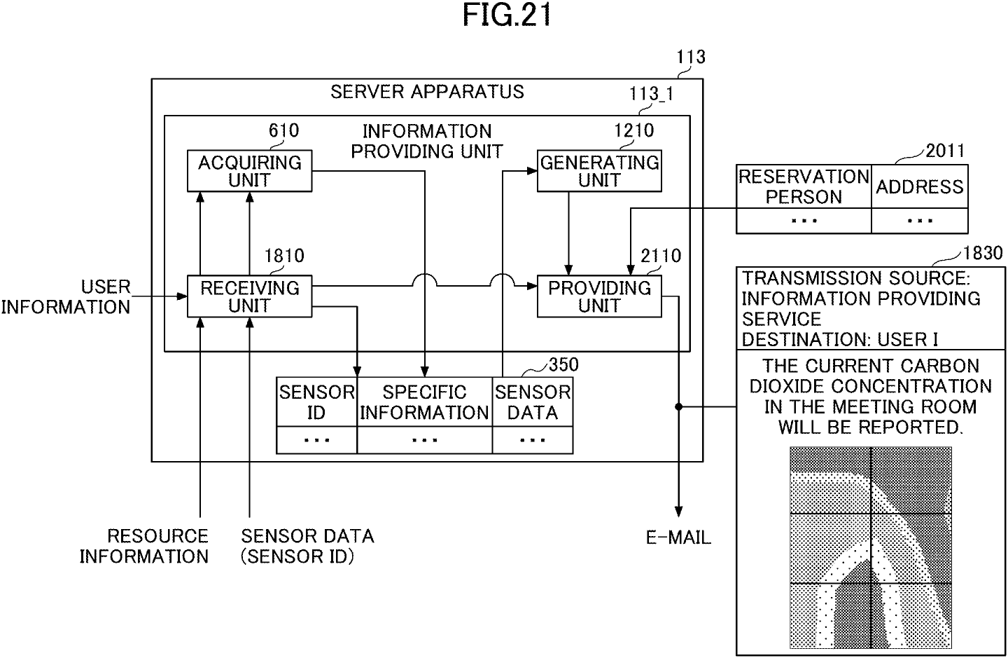

First, the system configuration of the entire network system including the information providing system according to the seventh embodiment will be described. FIG. 20 is a fourth diagram illustrating an example of the system configuration of the network system. The difference from the network system 1700 illustrated in FIG. 17 is that a network system 2000 illustrated in FIG. 20 includes a transmission destination information storage unit 2010 in which users and e-mail addresses are stored in association with each other.

The transmission destination information storage unit 2010 stores transmission destination information 2011. The transmission destination information 2011 includes “reservation person” and “address” as items of information. Among these, the name of a user (that is, all users who can use one predetermined meeting room) that may be stored in the user information 1712 of one predetermined meeting room is stored in the “reservation person”. The e-mail address for transmitting an e-mail to the corresponding user via the e-mail app is stored in the “address”. In the example of FIG. 20, the transmission destination information storage unit 2010 is provided outside the server apparatus 113, but the transmission destination information storage unit 2010 may be provided inside the server apparatus 113.

### <Functional Configuration of the Information providing unit>

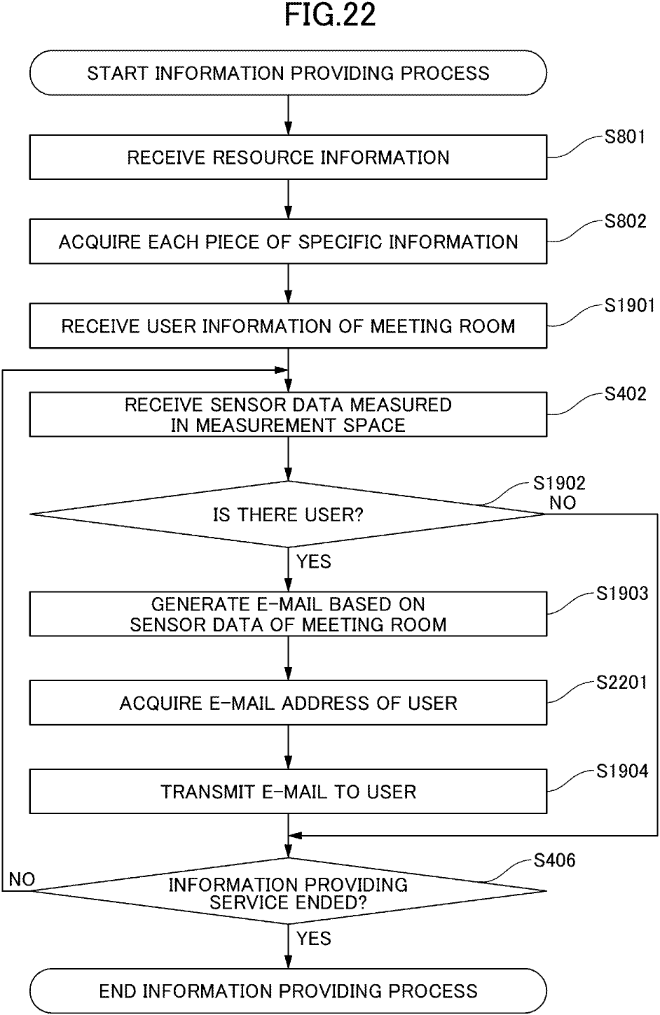

Next, the functional configuration of the information providing unit 113_1 will be described. FIG. 21 is a sixth diagram illustrating an example of the functional configuration of the information providing unit. The difference from the functional configuration of the information providing unit 113_1 illustrated in FIG. 18 is that in the case of the functional configuration of the information providing unit 113_1 illustrated in FIG. 21, the function of a providing unit 2110 is different from the function of the providing unit 1820 illustrated in FIG. 18.

The providing unit 2110 transmits the e-mail generated by the generating unit 1210 to the transmission destination via an e-mail app. The transmission destination to which the information providing unit 2110 transmits the e-mail is determined based on the user information 1712 reported by the receiving unit 1810 and the transmission destination information 2011 read from the transmission destination information storage unit 2010.

Specifically, the information providing unit 2110 identifies a user (a user who is currently using a meeting room) whose usage time is a time that includes the current time, among the “time” stored in the user information. Further, the providing unit 2110 identifies the e-mail address of the identified user based on the transmission destination information 2011, and transmits the e-mail 1830 via the e-mail app with the identified e-mail address as the transmission destination.

The e-mail 1830 transmitted by the providing unit 2110 is the same as the e-mail 1830 transmitted by the providing unit 1820 in FIG. 18, and, therefore, a description thereof is omitted here.

### <Flow of Information Providing Process>

Next, the flow of an information providing process by the server apparatus 113 of the information providing system 110 according to the seventh embodiment will be described. FIG. 22 is a sixth flow chart illustrating the flow of the information providing process. The difference from the fifth flow chart illustrated in FIG. 19 is step S2201.

In step S2201, the information providing unit 113_1 acquires the e-mail address of the user based on the user information 1712 and the transmission destination information 2011.

### <Summary>

As is clear from the above description, the information providing system 110 according to the seventh embodiment performs the flowing procedure in addition to the above sixth embodiment.
Identify the user’s e-mail address by referring to the transmission destination information storage unit 2010 in which the user’s e-mail address is stored in advance.

Thus, according to the seventh embodiment, the same effect as the sixth embodiment can be attained. Further, according to the seventh embodiment, the server apparatus 113 does not need to manage the user’s e-mail address in advance, and can acquire the user’s e-mail address by referring to the transmission destination information storage unit 2010.

### Other Embodiments

In the first to third embodiments above, the case where the generating units 330 and 910 generate a display screen with respect to the resource (and attribute information) specified in the output request is described. However, the method of generating display screens by the generating units 330 and 910 is not limited thereto, and for example, display screens with respect to all resources (and attribute information) may be generated. In this case, the providing units 340 and 920 select the display screens with respect to the resources (and attribute information) specified in the output request, from among the display screens generated by the generating units 330 and 910, and provide the selected display screens to the terminal 130.

In the seventh embodiment above, the case where the transmission destination information storage unit 2010 is connected to the server apparatus 113 has been described. However, the transmission destination information storage unit 2010 may be arranged in the transmission destination management server of a fourth managing system, for example. In this case, the server apparatus 113 receives the transmission destination information 2011 via the network 140.

In each of the above examples, the case of providing sensor data values, warnings, etc., as environment information has been described. However, the content provided as environment information is not limited to these.

For example, when environment information including warnings is provided, the user or administrator may provide, as a guide, measures to be taken to cause the value of sensor data to drop below the reference value.

In each of the above examples, the case of providing the value of sensor data as environment information has been described. However, the method of providing the value of sensor data as environment information is not limited thereto.

For example, when providing the values of multiple pieces of sensor data as environment information, the statistical values of multiple pieces of sensor data may be provided. Here, the statistical value includes the maximum value or the minimum value within the past predetermined time, the average value within the past predetermined time, the variance value, etc.

In each of the above embodiments, the case where the server apparatus 113 alone executes the information providing program has been described. However, the server apparatus 113 may be configured by, for example, multiple computers, and by installing an information providing program in each computer, the information providing program may be executed in the form of distributed computing.

Note that the present invention is not limited to the configurations described herein, such as by combining the above configurations with other elements. These points can be changed to the extent that the configurations do not deviate from the purpose of the present invention, and can be appropriately determined according to the form of the application.

According to one embodiment of the present invention, a mechanism for providing measurement information measured in a managing system to users in cooperation with the managing system, can be provided.

The information providing system, the information providing method, and the recording medium are not limited to the specific embodiments described in the detailed description, and variations and modifications may be made without departing from the spirit and scope of the present invention.

What is claimed is:

1. An information providing system comprising:
circuitry; and
a memory storing computer-executable instructions that cause the circuitry to execute:
connecting, via a network, to a first managing system configured to manage measurement information measured by a sensor;
receiving, from the first managing system, the measurement information of the sensor and identification information identifying the sensor that has measured the measurement information;
acquiring specific information corresponding to the received measurement information, from a storage in which the identification information of the sensor is associated with the specific information for specifying a resource on which the sensor is installed;
generating environment information to be provided to a terminal, based on the acquired specific information and the received measurement information; and
providing the generated environment information to the terminal.

2. The information providing system according to claim 1, wherein the acquiring includes acquiring the specific information corresponding to the received measurement information, by connecting, via the network, to a second managing system including the storage.

3. The information providing system according to claim 1, wherein the generating includes generating the environment information with respect to the specified resource, in response to receiving an output request from the terminal.

4. The information providing system according to claim 3, wherein
the output request includes information specifying the resource, and
the generating includes generating the environment information with respect to the resource specified in the output request.

5. The information providing system according to claim 3, wherein the generating includes generating the environment information according to an attribute of a user specified in the output request.

6. The information providing system according to claim 1, wherein the generating includes generating the environment information including a warning, in response to determining that the received measurement information satisfies a predetermined condition.

7. The information providing system according to claim 1, wherein
the generating includes storing, in a predetermined storage destination, the environment information with respect to the specified resource, and
the providing includes providing the environment information stored in the predetermined storage destination to the terminal that has made an output request, in response to determining that the output request is received from the terminal via a web browser.

8. The information providing system according to claim 1, wherein the circuitry is further caused to execute:
registering the specified resource, a timing of transmitting the environment information with respect to the specified resource, and a transmission destination to which the environment information with respect to the specified resource is to be transmitted, and wherein
the generating includes generating, at the registered timing, the environment information with respect to the registered specified resource, and
the providing includes transmitting, at the registered timing, the generated environment information to the terminal at the registered transmission destination.

9. The information providing system according to claim 8, wherein
the generating includes generating the environment information including a warning, in response to determining that the received measurement information satisfies a predetermined condition, and
the providing includes transmitting the generated environment information including the warning to the terminal at the registered transmission destination.

10. The information providing system according to claim 8, wherein the providing includes transmitting the environment information with respect to the registered specified resource, via an e-mail application or a messaging application.

11. The information providing system according to claim 1, wherein
the receiving includes receiving information of a user to use a predetermined space, by connecting, via the network, to a third managing system configured to manage the user to use the predetermined space and a usage time of using the predetermined space by the user, and
the providing includes determining, as a transmission destination, the terminal of the user who is currently using the predetermined space, based on the received information of the user, and transmitting the environment information to the determined transmission destination.

12. The information providing system according to claim 11, wherein the receiving includes receiving information of the transmission destination to which the environment information is to be transmitted at the providing, the transmission destination corresponding to the terminal of the user who is currently using the predetermined space, the information of the transmission destination being received by connecting, via the network, to a fourth managing system configured to manage the information of the user to use the predetermined space and the information of the transmission destination.

13. The information providing system according to claim 1, wherein the resource includes at least one of a space or an object on which the sensor is installed.

14. The information providing system according to claim 13, wherein the space includes a space in an architectural structure or a space in a vehicle.

15. The information providing system according to claim 1, wherein the measurement information includes carbon dioxide concentration, a temperature, a humidity, an airflow, a dust amount, an odor, a sound volume, or an illuminance.

16. An information providing method performed by an information providing system, the information providing method comprising:
connecting, via a network, to a managing system configured to manage measurement information measured by a sensor;
receiving, from the managing system, the measurement information of the sensor and identification information identifying the sensor that has measured the measurement information;
acquiring specific information corresponding to the received measurement information, from a storage in which the identification information of the sensor is associated with the specific information for specifying a resource on which the sensor is installed;
generating environment information to be provided to a terminal, based on the acquired specific information and the received measurement information; and
providing the generated environment information to the terminal.

17. A non-transitory computer-readable recording medium storing a program that causes a computer to execute a process performed in an information providing system, the process comprising:
connecting, via a network, to a managing system configured to manage measurement information measured by a sensor;
receiving, from the managing system, the measurement information of the sensor and identification information identifying the sensor that has measured the measurement information;
acquiring specific information corresponding to the received measurement information, from a storage in which the identification information of the sensor is associated with the specific information for specifying a resource on which the sensor is installed;
generating environment information to be provided to a terminal, based on the acquired specific information and the received measurement information; and
providing the generated environment information to the terminal.
